(19) United States
(12) Patent Application Publication
(10) Pub. No.: US 2019/0044216 A1
(43) Pub. Date: Feb. 7, 2019

(54) DUAL-BAND ANTENNA STRUCTURE

(71) Applicant: Quanta Computer Inc., Taoyuan City (TW)

(72) Inventors: Jun-Yu LU, Taoyuan City (TW); Hung-Ren HSU, Taoyuan City (TW); Chun-I LIN, Taoyuan City (TW); Hui LIN, Taoyuan City (TW)

(21) Appl. No.: 15/800,715

(22) Filed: Nov. 1, 2017

(30) Foreign Application Priority Data
Aug. 3, 2017 (TW) 106126209

(51) Int. Cl. H01Q 1/24; H01Q 7/00; H01Q 5/50; H01Q 9/04; H01Q 21/00; H01Q 1/38

(52) U.S. Cl. CPC H01Q 1/243; H01Q 7/00; H01Q 5/50; H04M 1/0283; H01Q 21/0006; H01Q 1/38; H01Q 9/0421

(57) ABSTRACT

A dual-band antenna structure includes a ground plane, a signal source, a coupling gap, a first feeding arm, a second feeding arm, a first radiation arm, and a second radiation arm. The first and second feeding arms are electrically coupled to the signal source. The first radiation arm has a first open end and a first grounding point. The second radiation arm has a second open end and a second grounding point. The first and second open ends are opposite each other. The first and second grounding points are electrically connected to the ground plane.

### CROSS REFERENCE TO RELATED APPLICATIONS

This Application claims priority of Taiwan Patent Application No. 106126209 filed on Aug. 3, 2017, the entirety of which is incorporated by reference herein.

### BACKGROUND OF THE INVENTION

### Field of the Invention

The disclosure generally relates to an antenna structure, and more specifically, to an antenna structure for use in a thin and light mobile device.

### Description of the Related Art

With the progress being made in mobile communication technology, mobile devices such as portable computers, mobile phones, tablet computers, multimedia players, and other hybrid functional mobile devices have become common. To satisfy the demands from users, mobile devices can usually perform wireless communication functions. Some functions cover a large wireless communication area; for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area; for example, mobile phones using Wi-Fi and Bluetooth systems and using frequency bands of 2.4 GHz, 5.2 GHz, and 5.8 GHz.

FIG. 1 is a diagram of antennas disposed in a communication device 10. FIG. 1 shows a conventional PCB (Printed Circuit Board) antenna design in which the height H of antennas 11 and 12 is from about 7 mm to about 10 mm since the height H required by the antennas occupies a lot of border area. Thus, if the antennas are disposed above an LCD (Liquid Crystal Display) module 13, it cannot meet the requirement of having a narrow border. In addition, the antennas disposed above the LCD module 13 may limit the appearance. It should be noted that if the communication device 10 uses a design that includes a metal back cover, the conventional antenna (e.g., the antenna structures 11 and 12 displayed in FIG. 1) will not provide effective radiation. Accordingly, the antennas should be moved adjacent to the system end. Such a design (e.g., the antenna structures 11 and 12) may receive too much system noise, thereby decreasing the total transmission speed.

With the development of mobile communication technology nowadays, there is a wide variety of diverse and abundant applications for wireless communication products. Consumers pay more attention to mobile communication devices that include metal back covers. To pursue market trends and satisfy consumer demand, many manufacturers are investing a lot of resources into researching mobile communication devices with metal back covers. However, metal back covers may shield the radiation energy from antennas and therefore ruin the performance of wireless transmission. It is an important issue for antenna engineers to develop a novel antenna for use in a mobile device including a metal back cover.

### BRIEF SUMMARY OF THE INVENTION

In order to solve the above technical problem, the invention proposes a communication device. An antenna structure of the communication device includes a ground plane, a signal source, a coupling gap, a first feeding arm, a second feeding arm, a first radiation arm, a second radiation arm, a bending element, a first grounding point, and a second grounding point. The communication device uses a nano-injection molding technique (NMT) process to integrate the antenna structure with a metal housing. In the invention, the antenna is designed at an edge of the metal housing, so as to effectively reduce the clearance required by the antenna. Thus, the proposed appearance design can meet the requirement of having a narrow border. Furthermore, in one embodiment of the invention, the antenna height is a mere 5 mm, which is suitable for application in today's thin and light mobile devices.

In a preferred embodiment, the invention provides a dual-band antenna structure. The dual-band antenna structure includes a ground plane, a coupling gap, a signal source, a first feeding arm, and a second feeding arm. The first feeding arm is electrically coupled to the signal source. The second feeding arm is electrically coupled to the signal source. The first radiation arm has a first open end and a first grounding point. The first grounding point is electrically connected to the ground plane. The second radiation arm has a second open end and a second grounding point. The first open end and the second open end are opposite to each other. The second grounding point is electrically connected to the ground plane.

In some embodiments, the dual-band antenna structure further includes a bending element which is electrically coupled to the first radiation arm. The signal source couples the energy through the first feeding arm to the first radiation arm, and further couples the energy through the second feeding arm to the second radiation arm. The first feeding arm is coupled through the first radiation arm and the bending element to the first grounding point, so as to form a first loop structure. The second feeding arm is coupled through the second radiation arm to the second grounding point, so as to form a second loop structure. By using the first coupling loop structure and the second coupling loop structure, the dual-band antenna structure operates in a first frequency band (2.4 GHz) and a second frequency band (5 GHz) which meet the wireless communication standard of 802.11 a/b/g/n/ac.

In some embodiments, a first coupling loop structure is formed by the first feeding arm and the first radiation arm through the coupling gap.

In some embodiments, a second coupling loop structure is formed by the second feeding arm and the second radiation arm through the coupling gap.

In some embodiments, the dual-band antenna structure further includes a bending element which is electrically coupled to the first radiation arm. The first feeding arm, the second feeding arm, the first radiation arm, the second radiation arm, the bending element, the first grounding point, and the second grounding point are all formed on a dielectric substrate by using a printing process, or are formed on a metal back cover by using a nano-injection molding technique (NMT).

In some embodiments, the signal source, the first feeding arm, the second feeding arm, the first radiation arm, the second radiation arm, the bending element, the first grounding point, and the second grounding point are all formed on the same plane.

In some embodiments, the bending element is a chip inductive element or a distributed inductive element.

In some embodiments, the length of the first radiation arm is substantially equal to an integer multiple of a quarter-wavelength of the operation frequency.

In some embodiments, the length of the second radiation arm is substantially equal to an integer multiple of a quarter-wavelength of the operation frequency.

### BRIEF DESCRIPTION OF DRAWINGS

The invention can be more fully understood by reading the subsequent detailed description and examples with references made to the accompanying drawings, wherein:

FIG. 1 is a diagram of a conventional antenna design;

FIGS. 2A and 2B are diagrams of antennas disposed in a communication device according to an embodiment of the invention;

FIG. 3 is a diagram of an antenna structure according to a first embodiment of the invention;

FIG. 4 is a diagram of return loss of an antenna structure according to another embodiment of the invention;

FIGS. 5A and 5B are diagrams of radiation efficiency of an antenna structure according to another embodiment of the invention;

FIG. 6 is a diagram of an antenna structure according to a second embodiment of the invention; and

FIG. 7 is a diagram of an antenna structure according to a third embodiment of the invention.

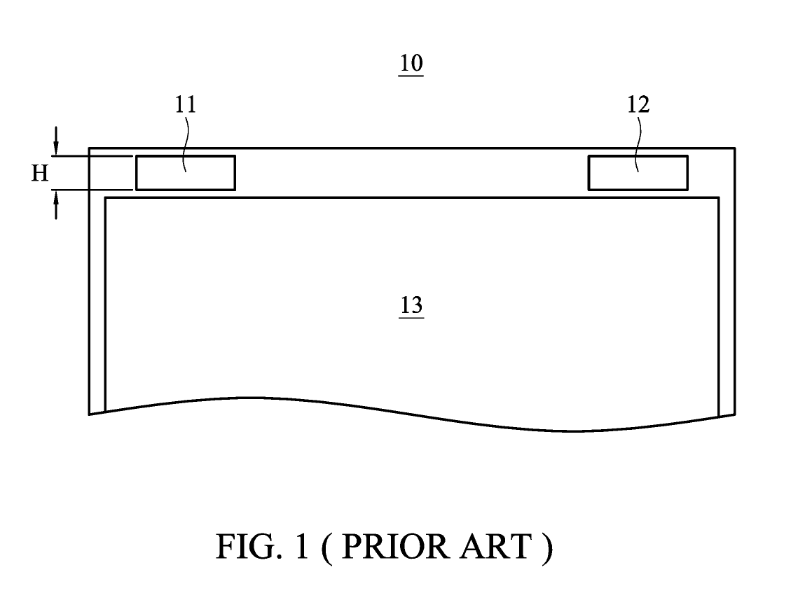

### DETAILED DESCRIPTION OF THE INVENTION

In order to illustrate the purposes, features and advantages of the invention, the embodiments and figures of the invention are described in detail below.

The invention uses a nano-injection molding technique (NMT) and hopes to combine an antenna with a metal housing. Accordingly, the heights of the antenna and a mechanism element are integrated, and the minimized antenna design is achieved at the same time. In conventional designs, if the antenna is disposed at an upper edge of an LCD (Liquid Crystal Display) module, the narrow border design cannot be achieved due to the limitation of the antenna height. In the invention, the antenna is directly disposed at the edge of the metal housing, and it is a low-profile design (its height is smaller than 5 mm). Therefore, the proposed antenna of the invention can be disposed at the narrow border region and suitable for used in a light and thin mobile device.

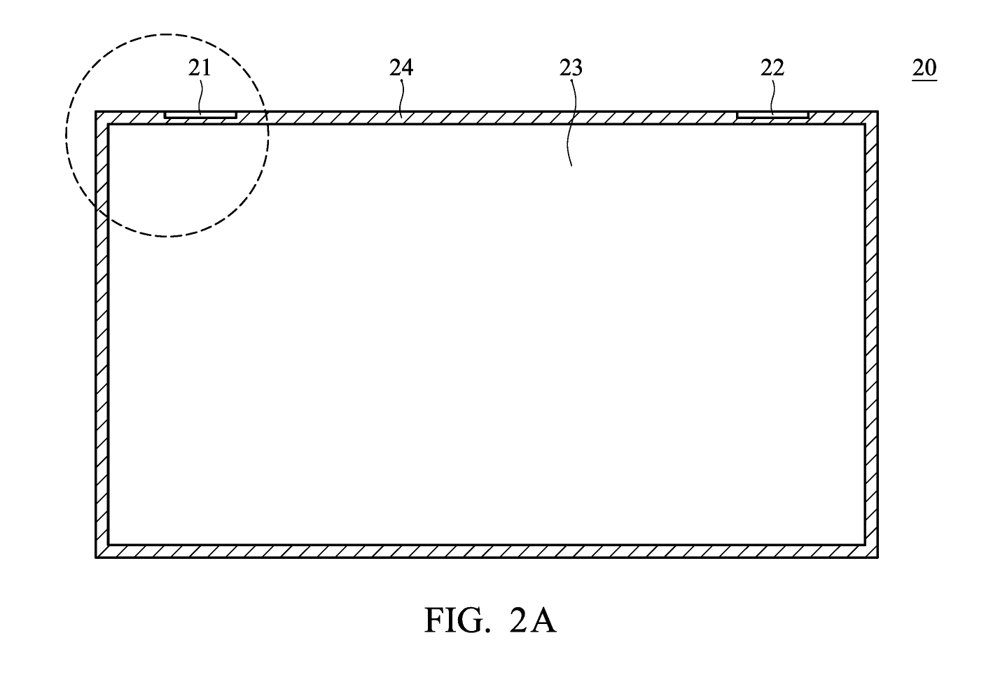

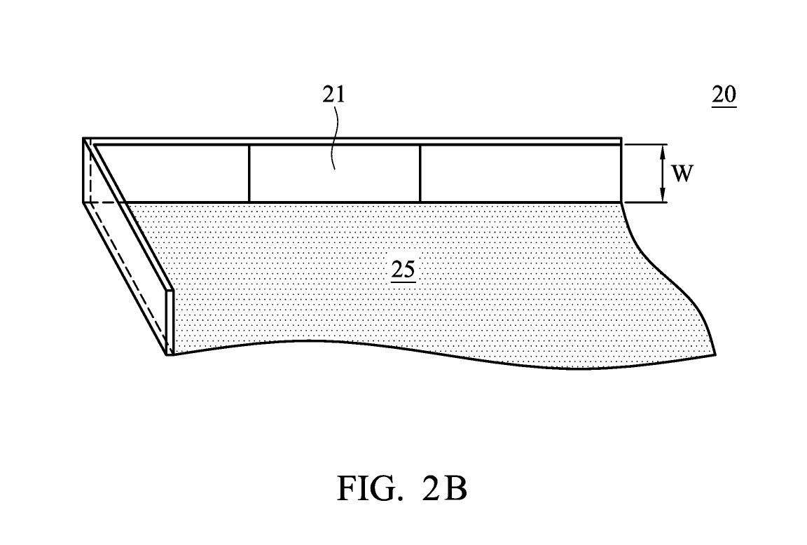

FIGS. 2A and 2B are diagrams of antennas disposed in a communication device 20 according to an embodiment of the invention. In the embodiment of the invention, the antenna structures 21 and 22 are a low-profile design (e.g., the antenna height W displayed in FIG. 2B is smaller than 5 mm), and are suitable for application in a typical light and thin communication device 20 (e.g., a tablet computer, a display device, a mobile phone, and a notebook computer). In the embodiment, the communication device 20 is a notebook computer, but the invention is not limited thereto. As shown in FIG. 2A, the antenna structures 21 and 22 are disposed within a narrow border region 24, so as to meet the requirement of having a narrow border. In addition, the antenna structures 21 and 22 are disposed above an LCD module 23, so as to avoid interference from system noise. As shown in FIG. 2A, furthermore, the metal portions of the antenna structures 21 and 22 can be manufactured together with a metal back cover 25 by using one manufacturing process (i.e., the “A component” of the notebook computer is integrally manufactured and formed). Next, the antenna structures 21 and 22 are effectively combined with the metal back cover 25 by using the nano-injection molding technique (NMT). Therefore, the antenna structures 21 and 22 are disposed inside the A component of the notebook computer, and the antenna structures 21 and 22 cannot be observed from the appearance.

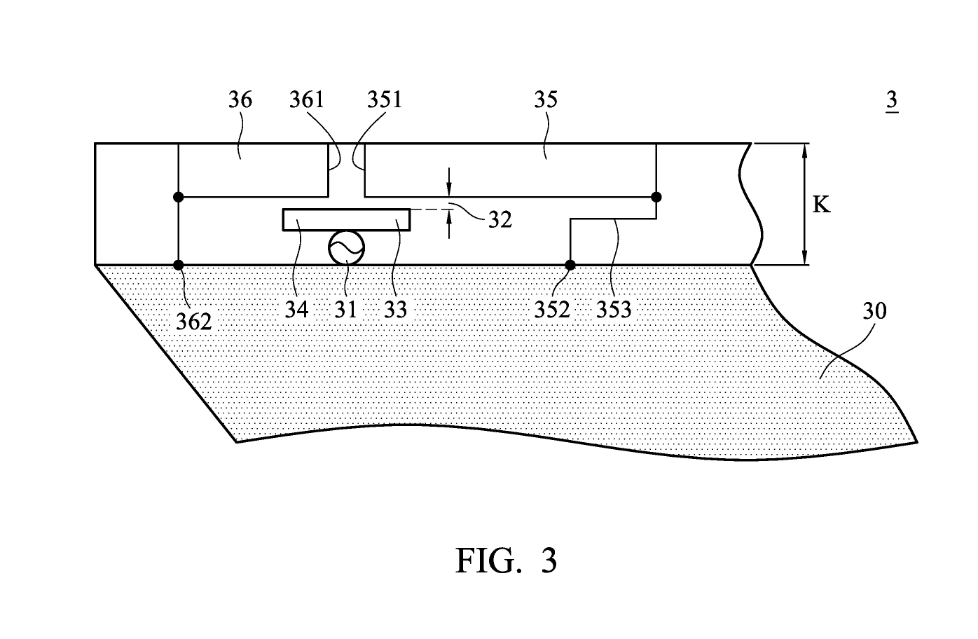

FIG. 3 is a diagram of an antenna structure 3 according to a first embodiment of the invention. In the first embodiment, the antenna structure 3 includes a system ground plane 30, a signal source 31, a coupling gap 32, a first feeding arm 33, a second feeding arm 34, a first radiation arm 35, and a second radiation arm 36. In some embodiments, the antenna structure 3 is a dual-band antenna structure, the height K of the antenna structure 3 is about 3 mm, and the system ground plane 30 is a metal back cover of the notebook computer or is a dielectric substrate. However, the invention is not limited to the above.

In the first embodiment, the signal source 31 is considered as an input terminal or an output terminal of the antenna structure 3. The first feeding arm 33 is electrically coupled to the signal source 31. The second feeding arm 34 is electrically coupled to the signal source 31. The first radiation arm 35 has a first open end 351 and a first grounding point 352. The first radiation arm 35 is electrically coupled to a bending element 353. The first grounding point 352 is electrically coupled to the system ground plane 30. The second radiation arm 36 has a second open end 361 and a second grounding point 362. The first open end 351 and the second open end 361 are opposite to each other. The second grounding point 362 is electrically coupled to the system ground plane 30. The first feeding arm 33 is disposed between the first radiation arm 35 and the system ground plane 30. The second feeding arm 34 is disposed between the second radiation arm 36 and the system ground plane 30. A first coupling loop structure is formed by the first feeding arm 33 and the first radiation arm 35 through the coupling gap 32 therebetween. A second coupling loop structure is formed by the second feeding arm 34 and the second radiation arm 36 through the coupling gap 32.

In the first embodiment, the first feeding arm 33, the second feeding arm 34, the first radiation arm 35, the second radiation arm 36, the bending element 353, the first grounding point 352, and the second grounding point 362 are all formed on a dielectric substrate by using a printing process. Alternatively, the first feeding arm 33, the second feeding arm 34, the first radiation arm 35, the second radiation arm 36, the bending element 353, the first grounding point 352, and the second grounding point 362 may be formed on a metal back cover by using a nano-injection molding technique (NMT). The signal source 31, the first feeding arm 33, the second feeding arm 34, the first radiation arm 35, the second radiation arm 36, the bending element 353, the first grounding point 352, and the second grounding point 362 may be all formed on the same plane. In the first embodiment, the length of the first radiation arm 35 is substantially equal to an integer multiple of a quarter-wavelength (λ/4) of the operation frequency, and the length of the second radiation arm 36 is substantially equal to an integer multiple of the quarter-wavelength (λ/4) of the operation frequency, but the invention is not limited thereto.

In the first embodiment, the signal source 31 couples the energy through the first feeding arm 33 to the first radiation arm 35, and further couples the energy through the second feeding arm 34 to the second radiation arm 36. The first feeding arm 33 is coupled through the first radiation arm 35 and the bending element 353 to the first grounding point 352, so as to form a first loop structure. The second feeding arm 34 is coupled through the second radiation arm 36 to the second grounding point 362, so as to form a second loop structure. The frequency band operations of 802.11 a/b/g/n/ac (2.4 GHz and 5 GHz bands) can be achieved by using the two loop structures.

In the first embodiment, the first feeding arm 33, the second feeding arm 34, the first radiation arm 35, the second radiation arm 36, the bending element 353, the first grounding point 352, and the second grounding point 362 may be all formed on a dielectric substrate by using a printing process. Alternatively, the first feeding arm 33, the second feeding arm 34, the first radiation arm 35, the second radiation arm 36, the bending element 353, the first grounding point 352, and the second grounding point 362 may be formed on a metal back cover by using a nano-injection molding technique (NMT).

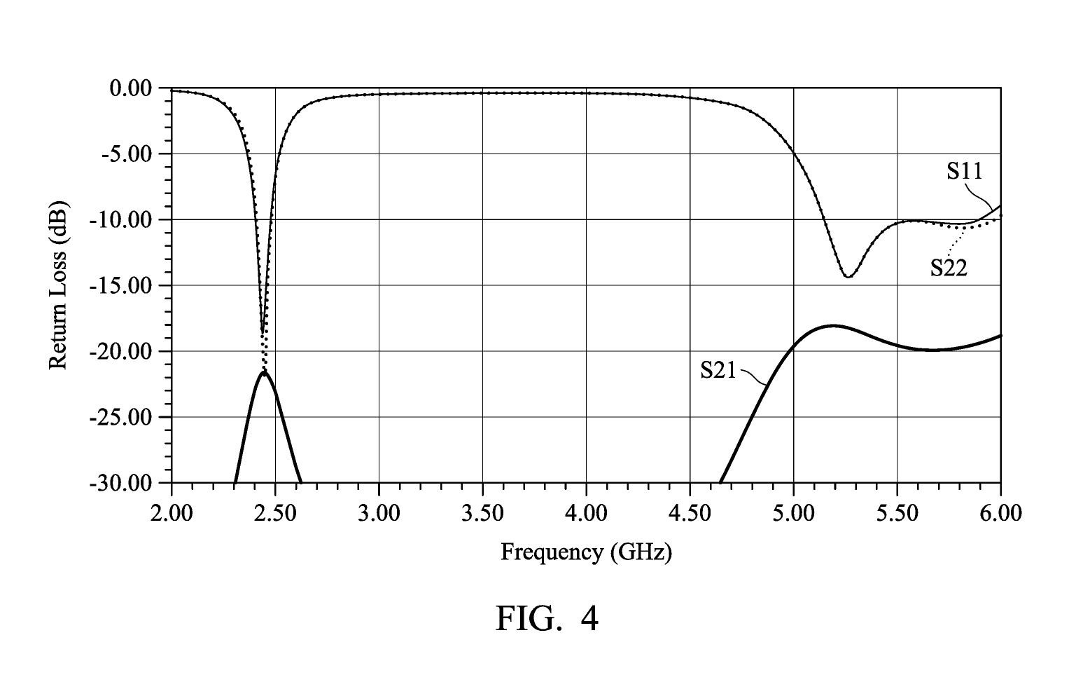

FIG. 4 is a diagram of return loss of the antenna structure 3 according to another embodiment of the invention. In the embodiment of FIG. 4, the system ground plane 30 of the antenna structure 3 has a length of about 350 mm, and a width of about 200 mm. Accordingly, the system ground plane 30 is substantially equal to the back cover size of a 15-inch notebook computer. In the embodiment of FIG. 4, there are two symmetrical antenna structures 3 disposed in the communication device. Each of the two antennas has a length of 30 mm and a width of 5 mm. Each antenna structure can cover the operation frequency bands of Wi-Fi 802.11 a/b/g/n/ac (from about 2400 MHz to about 2484 MHz, and further from about 5150 MHz to about 5875 MHz). In FIG. 4, according to the transmission coefficient S21 between the two antenna structures 3, the isolation between the two antenna structures 3 is lower than 18-dB return loss within the operation frequency band, and it can meet the requirements of practical application.

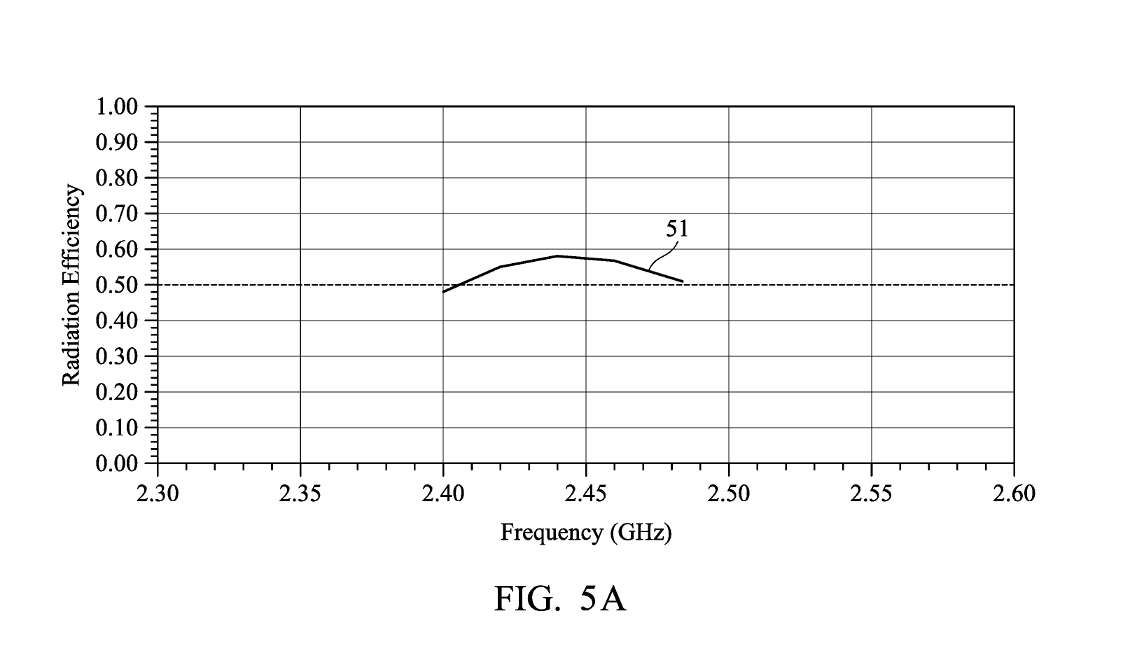

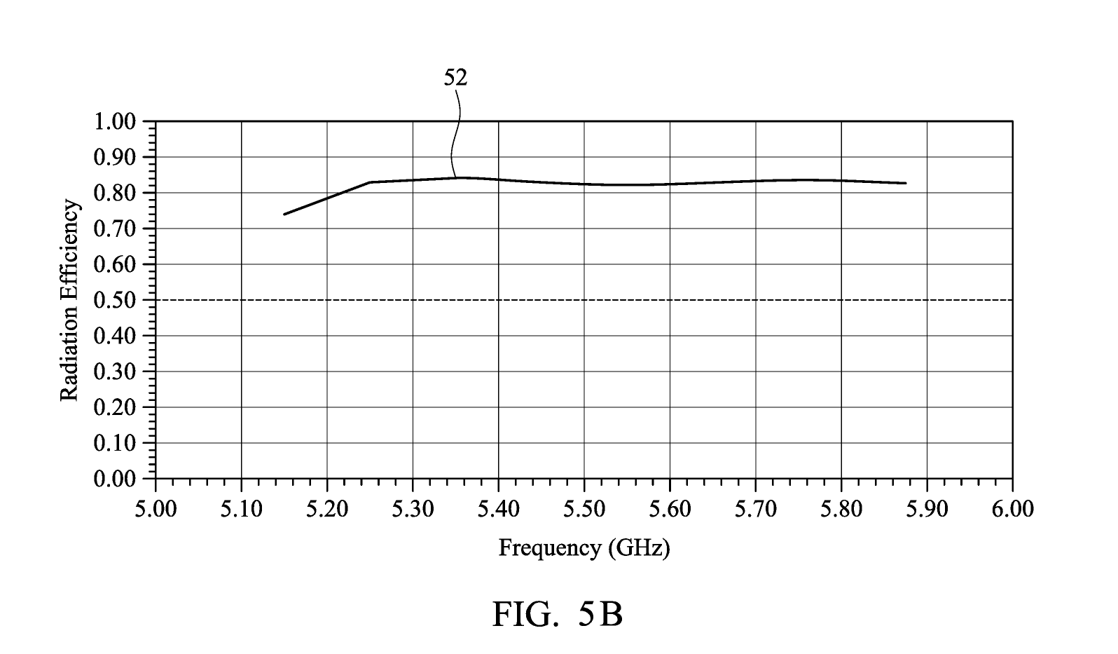

FIGS. 5A and 5B are diagrams of radiation efficiency of the antenna structure 3 according to another embodiment of the invention. In FIG. 5A, the radiation efficiency 51 of the antenna structure 3 operating in the frequency band of WLAN (Wireless Local Area Networks) 2.4 GHz (from 2400 MHz to 2484 MHz) is approximately from 49% to 58%. In FIG. 5B, the radiation efficiency 52 of the same antenna structure 3 operating in the frequency band of WLAN 5 GHz (from 5150 MHz to 5875 MHz) is approximately from 72% to 84%. Accordingly, with the small-size and low-profile antenna design, the antenna structure 3 of the invention has very good radiation efficiency performance, so as to be applicable to industries.

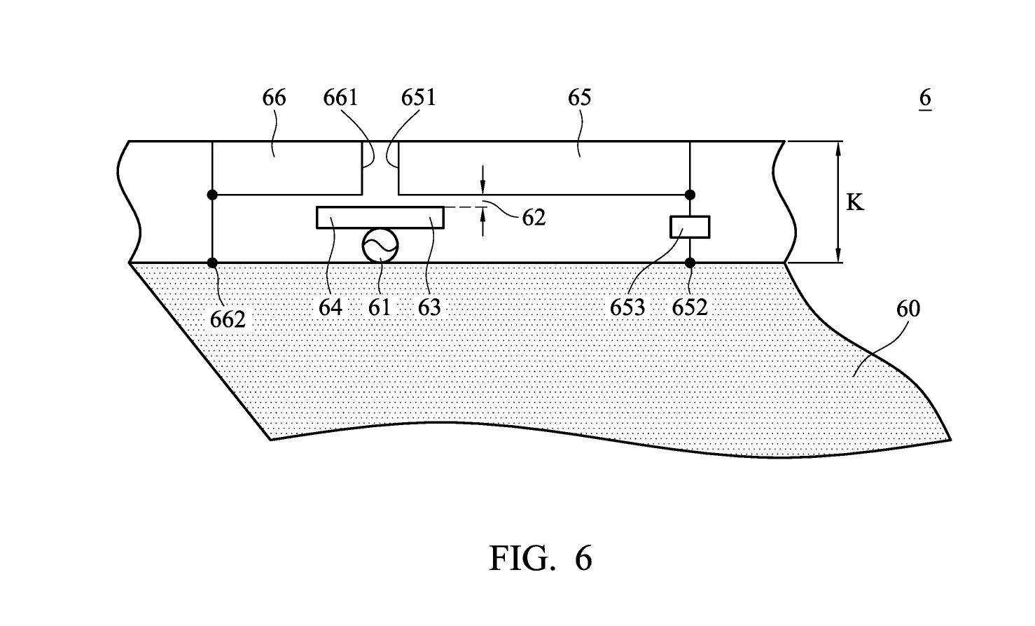

FIG. 6 is a diagram of an antenna structure 6 according to a second embodiment of the invention. In the second embodiment, the antenna structure 6 includes a system ground plane 60, a signal source 61, a coupling gap 62, a first feeding arm 63, a second feeding arm 64, a first radiation arm 65, and a second radiation arm 66. In some embodiments, the antenna structure 6 is a dual-band antenna structure, the height K of the antenna structure 6 is about 3 mm, and the system ground plane 60 is a metal back cover of the notebook computer or is a dielectric substrate. However, the invention is not limited to the above.

In the second embodiment, the signal source 61 is considered as an input terminal or an output terminal of the antenna structure 6. The first feeding arm 63 is electrically coupled to the signal source 61. The second feeding arm 64 is electrically coupled to the signal source 61. The first radiation arm 65 has a first open end 651 and a first grounding point 652. The first radiation arm 65 is electrically coupled to an inductive element 653. The inductive element 653 may be a chip inductive element or a distributed inductive element. The first grounding point 652 is electrically coupled to the system ground plane 60. The second radiation arm 66 has a second open end 661 and a second grounding point 662. The first open end 651 and the second open end 661 are opposite to each other. The second grounding point 662 is electrically coupled to the system ground plane 60. The first feeding arm 63 is disposed between the first radiation arm 65 and the system ground plane 60. The second feeding arm 64 is disposed between the second radiation arm 66 and the system ground plane 60. A first coupling loop structure is formed by the first feeding arm 63 and the first radiation arm 65 through the coupling gap 62 therebetween. A second coupling loop structure is formed by the second feeding arm 64 and the second radiation arm 66 through the coupling gap 62.

In the second embodiment, the first feeding arm 63, the second feeding arm 64, the first radiation arm 65, the second radiation arm 66, the inductive element 653, the first grounding point 652, and the second grounding point 662 are all formed on a dielectric substrate by using a printing process. Alternatively, the first feeding arm 63, the second feeding arm 64, the first radiation arm 65, the second radiation arm 66, the inductive element 653, the first grounding point 652, and the second grounding point 662 may be formed on a metal back cover by using a nano-injection molding technique (NMT). The signal source 61, the first feeding arm 63, the second feeding arm 64, the first radiation arm 65, the second radiation arm 66, the inductive element 653, the first grounding point 652, and the second grounding point 662 may be all formed on the same plane. In the second embodiment, the length of the first radiation arm 65 is substantially equal to an integer multiple of a quarter-wavelength (λ/4) of the operation frequency, and the length of the second radiation arm 66 is substantially equal to an integer multiple of the quarter-wavelength (λ/4) of the operation frequency, but the invention is not limited thereto.

In the second embodiment, the signal source 61 couples the energy through the first feeding arm 63 to the first radiation arm 65, and further couples the energy through the second feeding arm 64 to the second radiation arm 66. The first feeding arm 63 is coupled through the first radiation arm 65 and the inductive element 653 to the first grounding point 652, so as to form a first loop structure. The second feeding arm 64 is coupled through the second radiation arm 66 to the second grounding point 662, so as to form a second loop structure. The frequency band operations of 802.11 a/b/g/n/ac (2.4 GHz and 5 GHz bands) can be achieved by using the two loop structures.

In the second embodiment, the first feeding arm 63, the second feeding arm 64, the first radiation arm 65, the second radiation arm 66, the inductive element 653, the first grounding point 652, and the second grounding point 662 may be all formed on a dielectric substrate by using a printing process. Alternatively, the first feeding arm 63, the second feeding arm 64, the first radiation arm 65, the second radiation arm 66, the inductive element 653, the first grounding point 652, and the second grounding point 662 may be formed on a metal back cover by using a nano-injection molding technique (NMT).

The antenna structure 6 of the second embodiment is similar to the antenna structure 3 of the first embodiment. With the similar structures, the antenna structure 6 of the second embodiment can have the same performance as that of the antenna structure 3 of the first embodiment.

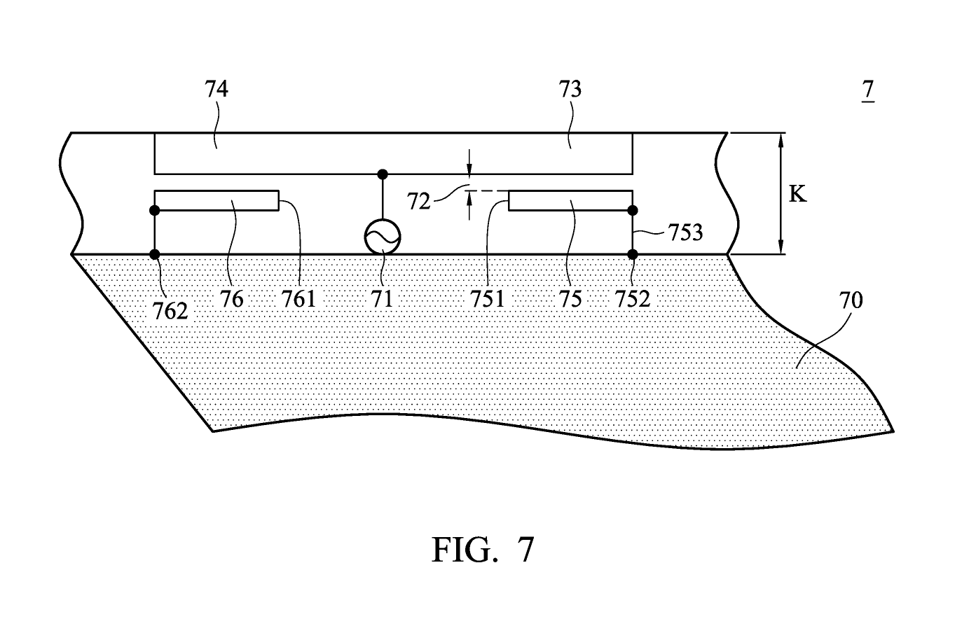

FIG. 7 is a diagram of an antenna structure 7 according to a third embodiment of the invention. In the third embodiment, the antenna structure 7 includes a system ground plane 70, a signal source 71, a coupling gap 72, a first feeding arm 73, a second feeding arm 74, a first radiation arm 75, and a second radiation arm 76. In some embodiments, the antenna structure 7 is a dual-band antenna structure, the height K of the antenna structure 7 is about 3 mm, and the system ground plane 70 is a metal back cover of the notebook computer or is a dielectric substrate. However, the invention is not limited to the above.

In the third embodiment, the signal source 71 is considered as an input terminal or an output terminal of the antenna structure 7. The first feeding arm 73 is electrically coupled to the signal source 71. The second feeding arm 74 is electrically coupled to the signal source 71. The first radiation arm 75 has a first open end 751 and a first grounding point 752. The first radiation arm 75 is electrically coupled to a bending element 753. The first grounding point 752 is electrically coupled to the system ground plane 70. The second radiation arm 76 has a second open end 761 and a second grounding point 762. The first open end 751 and the second open end 761 are opposite to each other. The second grounding point 762 is electrically coupled to the system ground plane 70.

In the third embodiment, the first feeding arm 73 and the second feeding arm 74 are disposed on the first radiation arm 75 and the second radiation arm 76. More specifically, the first radiation arm 75 is disposed between the first feeding arm 73 and the system ground plane 70, and the second radiation arm 76 is disposed between the second feeding arm 74 and the system ground plane 70. A first coupling loop structure is formed by the first feeding arm 73 and the first radiation arm 75 through the coupling gap 72 therebetween. A second coupling loop structure is formed by the second feeding arm 74 and the second radiation arm 76 through the coupling gap 72.

In the third embodiment, the first feeding arm 73, the second feeding arm 74, the first radiation arm 75, the second radiation arm 76, the first grounding point 752, and the second grounding point 762 are all formed on a dielectric substrate by using a printing process. Alternatively, the first feeding arm 73, the second feeding arm 74, the first radiation arm 75, the second radiation arm 76, the first grounding point 752, and the second grounding point 762 may be formed on a metal back cover by using a nano-injection molding technique (NMT). The signal source 71, the first feeding arm 73, the second feeding arm 74, the first radiation arm 75, the second radiation arm 76, the first grounding point 752, and the second grounding point 762 may be all formed on the same plane. In the third embodiment, the length of the first radiation arm 75 is substantially equal to an integer multiple of a quarter-wavelength (λ/4) of the operation frequency, and the length of the second radiation arm 76 is substantially equal to an integer multiple of the quarter-wavelength (λ/4) of the operation frequency, but the invention is not limited thereto.

In the third embodiment, the signal source 71 couples the energy through the first feeding arm 73 to the first radiation arm 75, and further couples the energy through the second feeding arm 74 to the second radiation arm 76. The first feeding arm 73 is coupled through the first radiation arm 75 to the first grounding point 752, so as to form a first loop structure. The second feeding arm 74 is coupled through the second radiation arm 76 to the second grounding point 762, so as to form a second loop structure. The frequency band operations of 802.11 a/b/g/n/ac (2.4 GHz and 5 GHz bands) can be achieved by using the two loop structures.

The antenna structure 7 of the third embodiment is similar to the antenna structure 3 of the first embodiment. With the similar structures, the antenna structure 7 of the third embodiment can have the same performance as that of the antenna structure 3 of the first embodiment.

Note that the above element sizes, element shapes, and frequency ranges are not limitations of the invention. An antenna designer can adjust these settings or values according to different requirements. It should be understood that the antenna structure of the invention is not limited to the configurations of FIGS. 2, 3, 6, and 7. The invention may merely include any one or more features of any one or more embodiments of FIGS. 2, 3, 6, and 7. In other words, not all of the features shown in the figures should be implemented in the dual-band antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A dual-band antenna structure, comprising:
a ground plane;
a signal source;
a coupling gap;
a first feeding arm, wherein the first feeding arm is electrically coupled to the signal source;
a second feeding arm, wherein the second feeding arm is electrically coupled to the signal source;
a first radiation arm, wherein the first radiation arm has a first open end and a first grounding point, and wherein the first grounding point is electrically connected to the ground plane; and
a second radiation arm, wherein the second radiation arm has a second open end and a second grounding point, wherein the first open end and the second open end are opposite to each other, and wherein the second grounding point is electrically connected to the ground plane.

2. The dual-band antenna structure as claimed in claim 1, wherein a first coupling loop structure is formed by the first feeding arm and the first radiation arm through the coupling gap.

3. The dual-band antenna structure as claimed in claim 1, wherein a second coupling loop structure is formed by the second feeding arm and the second radiation arm through the coupling gap.

4. The dual-band antenna structure as claimed in claim 1, wherein a first coupling loop structure is formed by the first feeding arm and the first radiation arm through the coupling gap, wherein a second coupling loop structure is formed by the second feeding arm and the second radiation arm through the coupling gap, and wherein the dual-band antenna structure uses the first coupling loop structure and the second coupling loop structure to operate in a first frequency band and a second frequency band.

5. The dual-band antenna structure as claimed in claim 1, further comprising:
a bending element, electrically coupled to the first radiation arm, wherein the first feeding arm, the second feeding arm, the first radiation arm, the second radiation arm, the bending element, the first grounding point, and the second grounding point are all formed on a dielectric substrate by using a printing process, or are formed on a metal back cover by using a nano-injection molding technique (NMT).

6. The dual-band antenna structure as claimed in claim 1, further comprising:
a bending element, electrically coupled to the first radiation arm, wherein the signal source, the first feeding arm, the second feeding arm, the first radiation arm, the second radiation arm, the bending element, the first grounding point, and the second grounding point are all formed on the same plane.

7. The dual-band antenna structure as claimed in claim 1, further comprising:
a bending element, electrically coupled to the first radiation arm, wherein the bending element is a chip inductive element or a distributed inductive element.

8. The dual-band antenna structure as claimed in claim 1, wherein a length of the first radiation arm is substantially equal to an integer multiple of a quarter-wavelength of an operation frequency.

9. The dual-band antenna structure as claimed in claim 1, wherein a length of the second radiation arm is substantially equal to an integer multiple of a quarter-wavelength of an operation frequency.

10. The dual-band antenna structure as claimed in claim 1, wherein the dual-band antenna structure is disposed within a narrow border of a communication device.
